(19) United States
(12) Patent Application Publication
(10) Pub. No.: US 2019/0204497 A1
(43) Pub. Date: Jul. 4, 2019

(54) LIGHT-GUIDE PLATE, BACKLIGHT ASSEMBLY AND DISPLAY DEVICE INCLUDING THE SAME

(71) Applicant: Samsung Display Co., LTD., Yongin-si (KR)

(72) Inventors: Sangmin JEON, Uiwang-si (KR); Seungjun YU, Cheonan-si (KR)

(21) Appl. No.: 16/030,953

(22) Filed: Jul. 10, 2018

(30) Foreign Application Priority Data
Dec. 29, 2017 (KR) 10-2017-0184290

(51) Int. Cl. F21V 8/00

(52) U.S. Cl. CPC G02B 6/0035; G02B 6/0043; G02B 6/0061; G02B 6/0038; G02B 6/0065; G02B 6/0056

(57) ABSTRACT

A light-guide plate includes a light-guide member through which light is guided to exit from an upper surface of the light-guide member; and a high refractive index member covering a lower surface of the light-guide member which is opposite to the upper surface thereof, the high refractive index member including: a first high-refractive layer and a second high-refractive layer having refractive indices equal to each other, each of the refractive indices being equal to or greater than a refractive index of the light-guide member; and a quantum dot pattern which changes a wavelength of light incident thereto, disposed between the first high-refractive layer and the second high-refractive layer to dispose the first high-refractive layer between the light-guide member and the quantum dot pattern.

This application claims priority to Korean Patent Application No. 10-2017-0184290 filed on Dec. 29, 2017, and all the benefits accruing therefrom under 35 U.S.C. § 119, the entire disclosure of which is incorporated by reference herein in its entirety.

### BACKGROUND

### 1. Field

Exemplary embodiments relate to a light-guide plate. More particularly, exemplary embodiments relate to a light-guide plate, a backlight assembly including the light-guide plate and a display device including the light-guide plate.

### 2. Description of the Related Art

A liquid crystal display device includes a liquid crystal display panel, which changes a light transmittivity of a liquid crystal to display an image, and a backlight assembly disposed under the liquid crystal display panel to provide a light to the liquid crystal display panel.

A technology using a quantum dot is being researched and developed to improve an image quality of the liquid crystal display device. However, a quantum dot has a relatively low oxidation stability and a relatively low heat resistance, and may affect a path of a light exiting from a light source. Thus, an efficient configuration using a quantum dot is desired for improving an image quality and a reliability of a display device.

### SUMMARY

Exemplary embodiments provide an organic light-emitting display device capable of relatively easily providing decorative function.

Exemplary embodiments provide a method for manufacturing the organic light-emitting display device.

According to an exemplary embodiment, a light-guide plate includes a light-guide member through which light is guided to exit from an upper surface of the light-guide member; and a high refractive index member covering a lower surface of the light-guide member which is opposite to the upper surface thereof, the high refractive index member including: a first high-refractive layer and a second high-refractive layer having refractive indices equal to each other, each of the refractive indices being equal to or greater than a refractive index of the light-guide member; and a quantum dot pattern which changes a wavelength of light incident thereto, disposed between the first high-refractive layer and the second high-refractive layer to dispose the first high-refractive layer between the light-guide member and the quantum dot pattern. An interface is formed between the second high-refractive layer, and each of the first high-refractive layer and the quantum dot pattern, respectively.

In an exemplary embodiment, the light-guide member may include a material having a refractive index of about 1.4 to about 1.6.

In an exemplary embodiment, the light-guide member may include glass.

In an exemplary embodiment, the first high-refractive layer may include at least one selected from polymethylmethacrylate, polycarbonate and polycycloolefin.

In an exemplary embodiment, the second high-refractive layer may include a same material as the first high-refractive layer.

In an exemplary embodiment, the first high-refractive layer may include a metal oxide.

In an exemplary embodiment, the light-guide plate may further include a wire grid polarizer which selectively transmits or reflects light incident thereto, the wire grid polarizer disposing the light-guide member between the first high-refractive layer and the wire grid polarizer and defining a light exit surface of the light-guide plate.

In an exemplary embodiment, the light-guide plate may further include a wire grid polarizer which selectively transmits or reflects light incident thereto, the wire grid polarizer disposed between the light-guide member and the first high-refractive layer.

In an exemplary embodiment, the light-guide plate may further include a lenticular pattern covering the upper surface of the light-guide member, the lenticular pattern disposing the light-guide member between the first high-refractive layer and the lenticular pattern and defining a light exit surface of the light-guide plate.

According to an exemplary embodiment, a backlight assembly includes a light source which generates and emits light; and a light-guide plate which guides the light emitted from the light source to exit from the light-guide plate. The light-guide plate includes: a light-guide member through which the light emitted from the light source is guided to exit from an upper surface of the light-guide member, the light-guide member including an incident side surface through which the light emitted from the light source is incident into the light-guide member; and a high refractive index member covering a lower surface of the light-guide member which is opposite to the upper surface thereof. The high refractive index member includes: a first high-refractive layer and a second high-refractive layer having refractive indices equal to each other, each of the refractive indices being equal to or greater than a refractive index of the light-guide member; and a quantum dot pattern which changes a wavelength of light incident thereto, disposed between the first high-refractive layer and the second high-refractive layer to dispose the first high-refractive layer between the light-guide member and the quantum dot pattern. An interface is formed between the second high-refractive layer, and each of the first high-refractive layer and the quantum dot pattern, respectively.

In an exemplary embodiment, the quantum dot pattern may be provided in plurality between the first high-refractive layer and the second high-refractive layer, and an area density of the quantum dot pattern may be larger in a first area adjacent to the incident side surface than in a second area adjacent to an opposite surface opposing the incident side surface.

In an exemplary embodiment, the light source may be provided in plurality arranged along the incident side surface of the light-guide member. Extending from the incident side surface in a direction away therefrom may be: a low brightness area between adjacent light sources, and a high brightness area at the light sources. An area density of the quantum dot pattern may be larger in the low brightness area than in the high brightness area.

According to an exemplary embodiment, a display device includes a display panel which displays an image with light, and a backlight assembly which provides the light to the display panel. The backlight assembly includes a light source which generates and emits the light; and a light-guide plate which guides the light emitted from the light source to exit from the light-guide plate. The light-guide plate includes: a light-guide member through which the light emitted from the light source is guided to exit from an upper surface of the light-guide member, the light-guide member including an incident side surface through which the light emitted from the light source is incident into the light-guide member; and a high refractive index member covering a lower surface of the light-guide member which is opposite to the upper surface thereof. The high refractive index member includes: a first high-refractive layer and a second high-refractive layer having refractive indices equal to each other, each of the refractive indices being equal to or greater than a refractive index of the light-guide member; and a quantum dot pattern which changes a wavelength of light incident thereto, disposed between the first high-refractive layer and the second high-refractive layer to dispose the first high-refractive layer between the light-guide member and the quantum dot pattern. An interface is formed between the second high-refractive layer, and each of the first high-refractive layer and the quantum dot pattern, respectively.

According to one or more exemplary embodiments, a quantum dot pattern is disposed on a lower surface of a first high-refractive layer covering a lower surface of a light-guide member. A lower surface of the quantum dot pattern is covered by a second refractive layer having a substantially same refractive index as the first high-refractive layer. Thus, even though the light entering the quantum dot pattern is not scattered, the non-scattered light returns into the light-guide member, such that an incident angle and an exiting angle may be substantially same at an interface of the light-guide member. Thus, uniformity of a light exiting from the light-guide member to a display panel may be improved, and color coordinates for different viewing angles may be reliably controlled.

Furthermore, the first high-refractive layer may planarize the light-guide member, and may increase adhesion of the quantum dot pattern within the light-guide plate.

Furthermore, the quantum dot pattern is disposed between the first and second refractive layers to be protected from outside the light-guide plate.

### BRIEF DESCRIPTION OF THE DRAWINGS

Features of one or more exemplary embodiments of the invention will be more clearly understood from the following detailed description taken in conjunction with the accompanying drawings.

FIG. 1 is an exploded cross-sectional view illustrating an exemplary embodiment of a display device according to the invention.

FIG. 2 is an enlarged cross-sectional view illustrating an exemplary embodiment of a quantum dot pattern of a display device according to the invention.

FIG. 3 is an enlarged cross-sectional view illustrating a comparative example of a quantum dot pattern of a display device.

FIGS. 4 and 5 are top plan views illustrating exemplary embodiments of a quantum dot pattern array of a display device according to the invention.

FIGS. 6 and 7 are cross-sectional views illustrating modified exemplary embodiments of a backlight assembly of a display device according to the invention.

FIG. 8 is a front side view illustrating another exemplary embodiment of a backlight assembly of a display device according to the invention.

FIG. 9 is a cross-sectional view illustrating still another exemplary embodiment of a backlight assembly of a display device according to the invention.

FIG. 10 is a top plan view illustrating an exemplary embodiment of a light source relative to a quantum dot pattern array of a backlight assembly of a display device according to the invention.

### DETAILED DESCRIPTION

A light-guide plate, a backlight assembly and a display device according to exemplary embodiments of the invention will be described hereinafter with reference to the accompanying drawings, in which some exemplary embodiments are shown. Same or similar reference numerals may be used for same or similar elements in the drawings.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

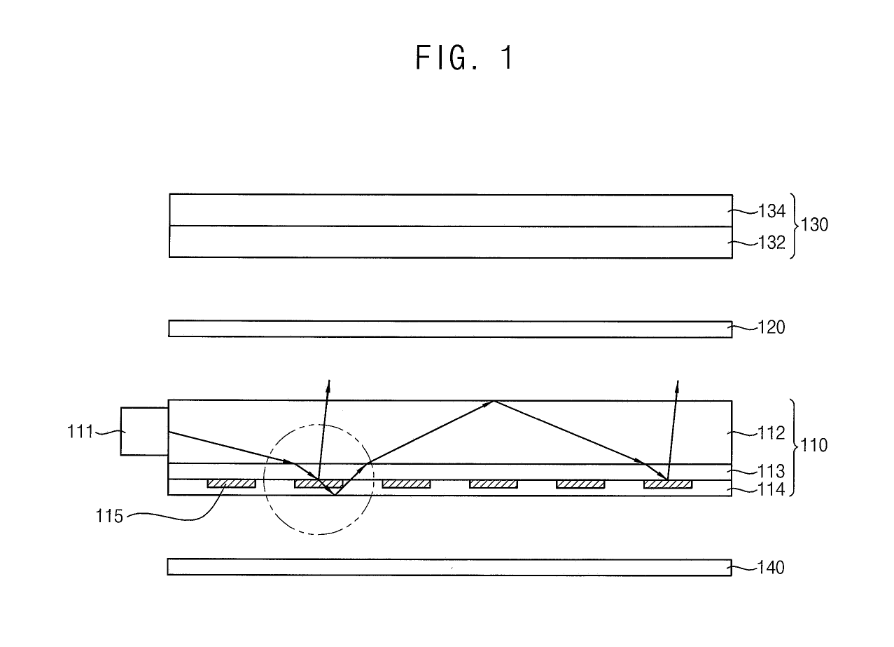

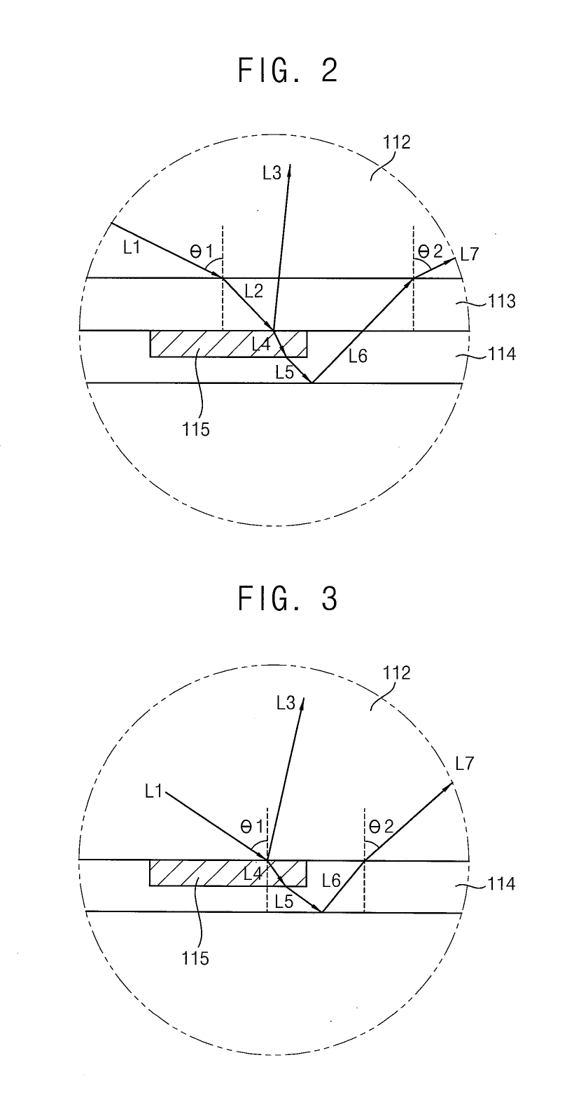

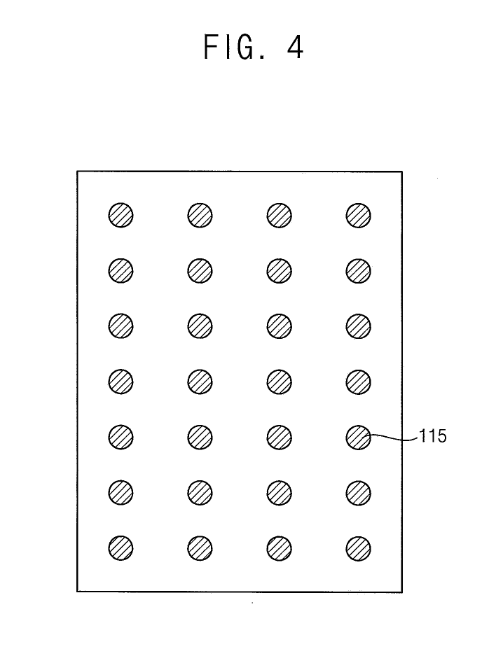

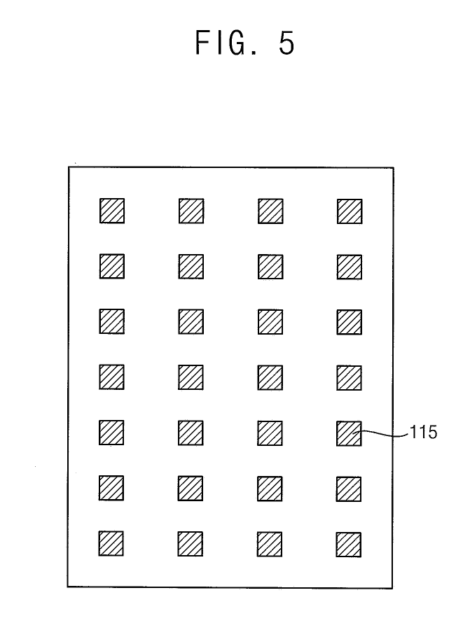

FIG. 1 is an exploded cross-sectional view illustrating an exemplary embodiment of a display device according to the invention. FIG. 2 is an enlarged cross-sectional view illustrating an exemplary embodiment of a quantum dot pattern of a display device according to the invention. FIG. 3 is an enlarged cross-sectional view illustrating a comparative exemplary of a quantum dot pattern of a display device. FIGS. 4 and 5 are top plan views illustrating an exemplary embodiment of a quantum dot pattern array of a display device according to the invention.

Referring to FIG. 1, a display device includes a backlight assembly 110 and a display panel such as a liquid crystal display panel 130. The backlight assembly 110 generates a light. The liquid crystal display panel 130 may display an image using the light generated by the backlight assembly 110.

The display device and components thereof may be disposed in a plane defined by first and second directions which cross each other. The horizontal direction in FIGS. 1 to 5 may represent the first direction or the second direction. The vertical direction in FIGS. 4 and 5 may represent the other one of the first direction and the second direction. A thickness of the display device and components thereof, is taken along a third direction crossing each of the first and second directions. The vertical direction in FIGS. 1-3 may represent the thickness direction, while a direction into the view or page of FIGS. 4 and 5 represents the thickness direction.

In an exemplary embodiment, at least one optical member 120 may be disposed between the liquid crystal display panel 130 and the backlight assembly 110. Furthermore, a reflection member 140 may be disposed on a lower surface of the backlight assembly 110 to reflect a light exiting downwardly from the backlight assembly 110 back towards the backlight assembly 110.

The optical member 120 may adjust a property of a light exiting from the backlight assembly 110. The optical member 120 may include at least one optical sheet. In an exemplary embodiment, for example, the optical member 120 may include one or more individual sheet such as a diffusion sheet for diffusing a light, a condensing sheet for condensing a light, or an integral sheet having both functions of the diffusion sheet and the condensing sheet.

In an exemplary embodiment, the liquid crystal display panel 130 may include a first (display) substrate 132, a second (display) substrate 134 and an optical transmittance layer such as a liquid crystal layer interposed between the first substrate 132 and the second substrate 134.

In an exemplary embodiment, for example, the first substrate 132 may include a thin film transistor array. In an exemplary embodiment, for example, the first substrate 132 may include a gate (signal) line extending in a direction, a data (signal) line crossing the gate line, a switching element such as a thin film transistor electrically connected to the gate line and the date line, and a pixel electrode electrically connected to the thin film transistor. The pixel electrode may include a transparent conductive material such as indium tin oxide, indium zinc oxide or the like. The aforementioned elements may be provided in plurality within the first substrate 132, such as being disposed on a base substrate thereof.

In an exemplary embodiment, for example, the second substrate 134 may include a common electrode, a color filter and a black matrix. The black matrix may have a matrix shape having or defining a plurality of openings arranged in a row direction and in a column direction. The color filter may overlap one or more of the openings. The color filter and the opening may overlap the pixel electrode. In an exemplary embodiment, for example, the common electrode may be disposed or formed on an entirety of a lower surface of a base substrate within the second substrate 134 to form a continuous layer, or may be patterned. The aforementioned elements may be provided in plurality within the second substrate 134.

However, exemplary embodiments are limited thereto. At least one of the common electrode, the color filter and the black matrix may be disposed in the first substrate 132 such as on the base substrate thereof.

The color filter may represent a primary color. In an exemplary embodiment, for example, the color filter may represent at least one of red, green, blue, yellow, magenta and cyan.

In an exemplary embodiment, for example, the gate line may provide a gate signal to a gate electrode of the thin film transistor. The data line may provide a data signal to a source electrode of the thin film transistor. When the thin film transistor is turned on by the gate signal, the data signal is transmitted to the pixel electrode through the drain electrode to provide a pixel voltage to the pixel electrode. An electric field may be formed between the pixel electrode and the common electrode by a voltage difference between the pixel voltage and a common voltage applied to the common electrode. Liquid crystal molecules of the liquid crystal layer are orientated by the electric field to control a transmittivity of a light passing through the liquid crystal layer thereby displaying an image.

In an exemplary embodiment, the backlight assembly 110 includes a light source 111 and a light-guide plate which transfers a light from the light source 111 to the liquid crystal display panel 130. The light-guide plate may include a light-guide member 112, a first high-refractive layer 113 covering a lower surface of the light-guide member 112, a quantum dot pattern 115 disposed on a lower surface of the first high-refractive layer 113 to expose portions of the lower surface, and a second high-refractive layer 114 covering the quantum dot pattern 115 and the exposed portions of the lower surface of the first high-refractive layer 113.

The light source 111 includes a light source generating a light. The light source may be disposed on a substrate. The light source may be provided in plurality on the substrate. The substrate may support the light source and provide a power to the light source. In an exemplary embodiment, for example, the substrate may be a printed circuit board.

The light source 111 may be disposed to face a first surface of the light-guide member 112. A light generated in the light source 111 may enter the light-guide member 112 through the first surface of the light-guide member 112. Thus, the first surface may be defined as an incident surface. The first surface may be a side surface of the light-guide member 112. Thus, the backlight assembly 110 may be edge-typed since the light source 111 faces the incident side surface of the light-guide member 112. The light-guide member 112 may include the lower surface facing the first high refractive layer 113, an upper surface through which light is emitted from the backlight assembly 110 and side surfaces which each connect the lower surface and the upper surface to each other.

In an exemplary embodiment, the light source 111 may be further disposed on a second (side) surface of the light-guide member 112 which opposes to the first (side) surface thereof. In another exemplary embodiment, the light source 111 may be disposed on four side surfaces of the light-guide member 112 to surround the light-guide member 112.

In an exemplary embodiment, the light source 111 may be a point light source such as a light-emitting diode (“LED”) package including a light-emitting diode chip. In an exemplary embodiment, for example, the light source 111 may include a plurality of point light sources arranged along a length of the first surface and spaced apart from each other by a predetermined distance. In an exemplary embodiment, for example, the light source 111 may generate a white light, a blue light or an ultraviolet (“UV”) light. In another exemplary embodiment, the light source 111 may include a linear light source such as a cold cathode fluorescent lamp (“CCFL”) or the like.

In an exemplary embodiment, for example, the light-guide member 112 may have a cross-section having a rectangular shape or a wedge shape.

The quantum dot pattern 115 includes a quantum dot. The quantum dot pattern 115 may be a discrete pattern provided in plurality at the lower surface of the first high-refractive layer 113 to expose portions of the lower surface. A quantum dot may be defined as a nano-particle of a semiconductor material, which has a diameter no more than about 100 nanometers (nm). The quantum dot may have a quantum confinement effect. Thus, the quantum dot may change a wavelength of a light emitted by the light source and incident to the quantum dot pattern 115.

In an exemplary embodiment, the quantum dot may include a II-VI group compound, a III-V group compound, a IV-VI group compound, a IV group element, a IV group compound or a combination thereof.

In an exemplary embodiment, for example, the II-VI group compound may include a binary compound selected from CdSe, CdTe, ZnS, ZnSe, ZnTe, ZnO, HgS, HgSe, HgTe, MgSe, MgS and a combination thereof, a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS and a combination thereof, or a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe and a combination thereof.

In an exemplary embodiment, for example, the III-V group compound may include a binary compound selected from GaN, GaP, GaAs, GaSb, AlN, AlP, AlAs, AlSb, InN, InP, InAs, InSb and a combination thereof, a ternary compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP and a combination thereof, or a quaternary compound selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb and a combination thereof.

In an exemplary embodiment, for example, the IV-VI group compound may include a binary compound selected from SnS, SnSe, SnTe, PbS, PbSe, PbTe and a combination thereof, a ternary compound selected from SnSeS, SnSeTe, SnSTe, PbSeS, PbSeTe, PbSTe, SnPbS, SnPbSe, SnPbTe and a combination thereof, or a quaternary compound selected from SnPbSSe, SnPbSeTe, SnPbSTe and a combination thereof.

In an exemplary embodiment, for example, the IV group element may include Si, Ge or a combination thereof. The IV group compound may include a binary compound selected from SiC, SiGe and a combination thereof.

In an exemplary embodiment, for example, the quantum dot may have a core-shell structure including a core and a shell which surrounds the core. In an exemplary embodiment, for example, the core and the shell may include different materials.

The quantum dot pattern 115 may further include a scattering particle to scatter an incident light. In an exemplary embodiment, for example, the scattering particle may include TiO₂, Al₂O₃, SiO₂ or a combination thereof.

The quantum dot and the scattering particle may be dispersed in a base or body such as including a cured resin. In an exemplary embodiment, for example, the quantum dot pattern 115 may be disposed or formed on a surface of the first high-refractive layer 113, for example, by printing. In an exemplary embodiment of a method of manufacturing a display device, for example, a combination including the quantum dot, the scattering particle, an antioxidant or the like may be coated on a surface and cured to form the quantum dot pattern 115 on the surface. The combination may include a binder resin such as an epoxy resin, a phenolic resin, a melamine resin, an urea resin or the like, a reactive monomer capable of forming a cured resin through cross-linking reaction, such as acrylate, or a combination thereof.

In an exemplary embodiment, the first and second high-refractive layers 113 and 114 may have a refractive index equal to or greater than that of the light-guide member 112. In one exemplary embodiment, the first and second high-refractive layers 113 and 114 may have a substantially same refractive index as each other.

Referring to FIG. 2, when the first high-refractive layer 113 has a refractive index equal to or more than a refractive index of the light-guide member 112, a light L1 incident on the lower surface of the light-guide member 112 may enter the first high-refractive layer 113. When the light enters the first high-refractive layer 113, the light may refract at interface between the first high-refractive layer 113 and the light-guide member 112. Thus, a light L2 progressing in the first high-refractive layer 113 from the interface may progress in a different direction from the light L1 incident on the interface of the first high-refractive layer 113 and the light-guide member 112.

The light L2 may enter the quantum dot pattern 115 at an interface between the first high-refractive layer 113 and the quantum dot pattern 115. A portion of a light entering the quantum dot pattern 115 may be excited and scattered by the quantum dot pattern 115. The portion of the scattered and excited light L3 may enter the light-guide member 112 through the interface between the first high-refractive layer 113 and the light-guide member 112, and may exit through an upper surface of the light-guide member 112. Thus, a light entering the light-guide member 112 from the light source 111 may exit from the light-guide member 112 after being scattered by the quantum dot pattern 115.

In an exemplary embodiment, the light source 111 may generate a blue light, and the quantum dot pattern 115 may include a first quantum dot exciting the blue light to generate a green light, and a second quantum dot exciting the blue light to generate to a red light. As a result, the light exiting from the upper surface of the light-guide member 112 may be a white light formed by mixture of the blue light, the red light and the green light.

A portion of the light entering the quantum dot pattern 115 through the interface between the first high-refractive layer 113 and the quantum dot pattern 115 may not be scattered, but may pass through the quantum dot pattern 115. Since the quantum dot pattern 115 includes a different material from the first high-refractive layer 113, the quantum dot pattern 115 may have a refractive index different from the first high-refractive layer 113. Thus, a light L4 progressing in the quantum dot pattern 115 from the first high-refractive layer 113 may progress in a direction different from the light L2 progressing in the first high-refractive layer 113. The light L4 progressed in the different direction from light L2 exits as a light L5 from the lower surface of the quantum dot pattern 115 to progress into the second high-refractive layer 114 in a direction same as the light L2 progressing in the first high-refractive layer 113. The light L5 progressing in the second high-refractive layer 114 may be reflected (totally reflected) at a lower surface of the second high-refractive layer 114. A light L6 reflected at the lower surface of the second high-refractive layer 114 may pass through the interface between the first and second high-refractive layers 113 and 114 and through the first high-refractive layer 113 to enter the light-guide member 112. Light incident into the light-guide member 112 from the second high-refractive layer 114 passes through the light-guide member 112 as light L7, to finally exit from the upper surface of the light-guide member 112 and toward the display panel 130.

In an exemplary embodiment, the quantum dot pattern 115 is not disposed directly on the lower surface of the light-guide member 112, but disposed on the lower surface of the first high-refractive layer 113 which covers the lower surface of the light-guide member 112. The lower surface of the quantum dot pattern 115 is covered by the second refractive layer 114 having a substantially same refractive index as the first high-refractive layer 113. Thus, even though the light entering the quantum dot pattern 115 is not scattered thereby to return into the light-guide member 112, an incident angle 81 and an exiting angle 82 each relative to a direction normal to the upper surface of the light-guide member 112 may be substantially same at an interface of the light-guide member 112 with an outside of the backlight assembly 110. Thus, uniformity of an exiting light from the light-guide member 112 to the liquid crystal display panel 130 may be improved, and color coordinates for different viewing angles may be reliably controlled.

Unlike the above, as illustrated in the comparative example of FIG. 3, if a high-refractive layer does not exist between the light-guide member 112 and the quantum dot pattern 115, when the light entering the quantum dot pattern 115 is not scattered but returns into the light-guide member 112, the incident angle 81 and the exiting angle 82 may be different from each other at the upper surface of the light-guide member 112. The difference between the incident angle 81 and the exiting angle 82 may reduce uniformity of the exiting light, and may increase complexity of pattern optimization. Furthermore, when a path of the light is repeatedly changed, the light may not meet a condition for total reflection thereby undesirably exiting from the light-guide member 112 to be leaked therefrom.

In an exemplary embodiment, the quantum dot pattern 115 may have a thin film shape extending in a horizontal direction along the lower surface of the first high-refractive layer 113. The shape of the quantum dot pattern 115 may be advantageous for achieving uniformity of a light path. In an exemplary embodiment, for example, a cross-section of the quantum dot pattern 115 may have a rectangular shape or a trapezoidal shape, to have a flat lower surface at a distal end surface thereof furthest from the lower surface of the first high-refractive layer 113.

In an exemplary embodiment, a refractive index of the quantum dot pattern 115 may be substantially same as that of the first high-refractive layer 113 and/or the second high-refractive layer 114.

The first high-refractive layer 113 disposed between the light-guide member 112 and the quantum dot pattern 115 may planarize the lower surface of the light-guide member 112 and may improve adhesion of the quantum dot pattern 115 within the structure of the backlight assembly 110. Furthermore, the first high-refractive layer 113 may function as a buffer layer preventing and/or reducing bending of the light-guide member 112 due to material difference or the like with material layers disposed on the light-guide member 112.

Materials of the first and second high-refractive layers 113 and 114 may be selected depending a material of the light-guide member 112. In an exemplary embodiment, the first high-refractive layer 113 may include a material having a refractive index larger than the light-guide member 112. The first and second high-refractive layers 113 and 114 may include a same material as each other.

In an exemplary embodiment, the light-guide member 112 may include a material having a refractive index of about 1.4 to about 1.6. In an exemplary embodiment, for example, the light-guide member 112 may include glass (refractive index: 1.47-1.49), polymethylmethacrylate (refractive index: 1.49), polycarbonate (refractive index: 1.58), polycycloolefin (refractive index: 1.51-1.54), or a combination thereof.

In an exemplary embodiment, for example, when the light-guide member 112 includes glass, the first high-refractive layer 113 may include polymethylmethacrylate, polycarbonate, polycycloolefin or the like. In an exemplary embodiment, the second high-refractive layer 114 may have a substantially same refractive index as the first high-refractive layer 113.

In an exemplary embodiment, the first high-refractive layer 113 may include a metal oxide. In an exemplary embodiment, for example, the first high-refractive layer 113 may include aluminum oxide such as Al₂O₃ (refractive index: 1.63). The metal oxide such as aluminum oxide may block penetration of humidity or oxygen to the quantum dot pattern 115 thereby improving a stability of the quantum dot pattern 115. Examples of the metal oxide may further include tantalum oxide, hafnium oxide, zirconium oxide, titanium oxide or the like. The high-refractive layer including the metal oxide may be formed as a metal oxide film or as a resin layer including metal oxide particles.

Referring to FIG. 4, the quantum dot pattern 115 may be provided in plurality arranged in a matrix configuration in a row and a column. In an exemplary embodiment, the quantum dot patterns 115 may have a circular planar shape in a top plan view, however, exemplary embodiments are no limited thereto. The quantum dot pattern 115 may have a polygonal planar shape as illustrated in FIG. 5, an oval planar shape or the like.

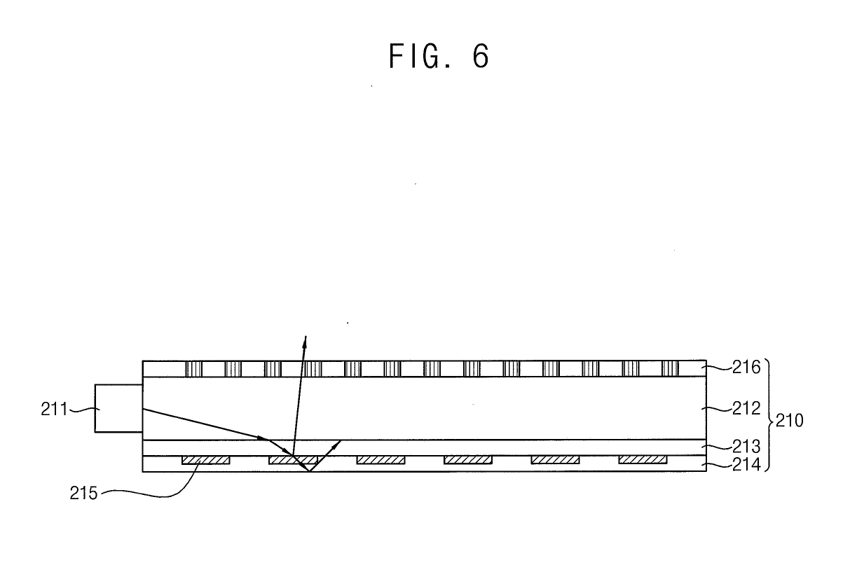

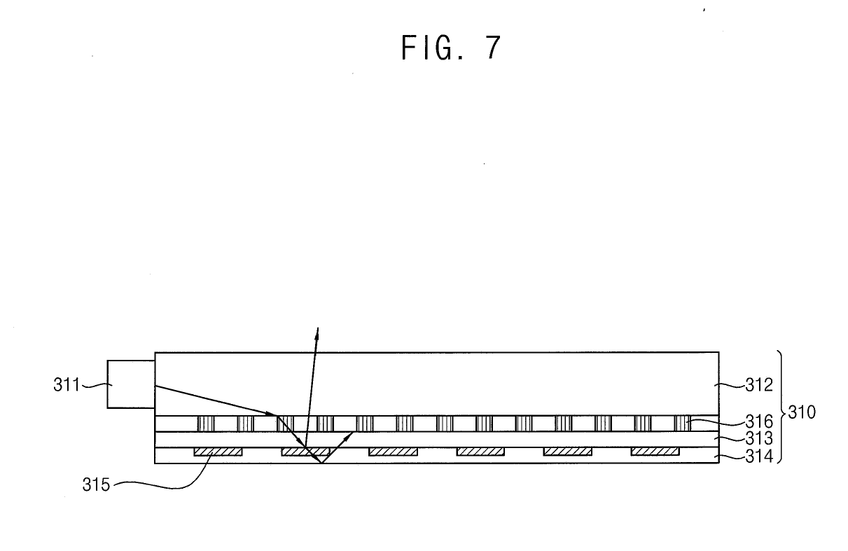

FIGS. 6 and 7 are cross-sectional views illustrating modified exemplary embodiments of a backlight assembly of a display device according to the invention.

Referring to FIG. 6, a backlight assembly 210 includes a light source 211 and a light-guide plate which transfers a light from the light source 211 to a display panel such as a liquid crystal display panel disposed on the backlight assembly 210. The light-guide plate may include a light-guide member 212, a first high-refractive layer 213 covering a lower surface of the light-guide member 212, a quantum dot pattern 215 disposed on a lower surface of the first high-refractive layer 213, and a second high-refractive layer 214 covering the quantum dot pattern 215 and the lower surface of the first high-refractive layer 213.

The light-guide plate further includes a wire grid polarizer 216 disposed on an upper surface of the light-guide member 212. An upper surface of the wire grid polarizer 216 may define the light exit surface of the backlight assembly 210.

The wire grid polarizer 216 may selectively transmit or reflect light incident thereto depending on polarization of the incident light. The light reflected by the wire grid polarizer 216 thereby returning into the light-guide member 212 may be repeatedly reflected in the light-guide member 212 to be eventually provided to the liquid crystal display panel. Thus, the wire grid polarizer 216 may be substituted for a dual brightness-enhancing film (“DBEF”).

The wire grid polarizer 216 may include a plurality of linear metal patterns lengthwise extending in a first direction and arranged in a second direction crossing the first direction such as being perpendicular thereto. Furthermore, a protective layer may be disposed on the linear metal patterns to form an air gap between the linear metal patterns and to protect the linear metal patterns.

In an exemplary embodiment of manufacturing a display device, the wire grid polarizer 216 may be formed directly on the upper surface of the light-guide member 212. In an exemplary embodiment, for example, the wire grid polarizer 216 may be formed by an imprinting method, a photolithography or the like.

Referring to FIG. 7, a backlight assembly 310 includes a light source 311 and a light-guide plate which transfers a light from the light source 311 to a display panel such as a liquid crystal display panel disposed on the backlight assembly 310. The light-guide plate may include a light-guide member 312, a wire grid polarizer 316 covering a lower surface of the light-guide member 312, a first high-refractive layer 313 covering a lower surface of the wire grid polarizer 316, a quantum dot pattern 315 disposed on a lower surface of the first high-refractive layer 313, and a second high-refractive layer 314 covering the quantum dot pattern 315 and the lower surface of the first high-refractive layer 313. An upper surface of the light-guide member 312 may define the light exit surface of the backlight assembly 310.

As illustrated in FIG. 7, the wire grid polarizer 316 may be disposed on the lower surface of the light-guide member 312.

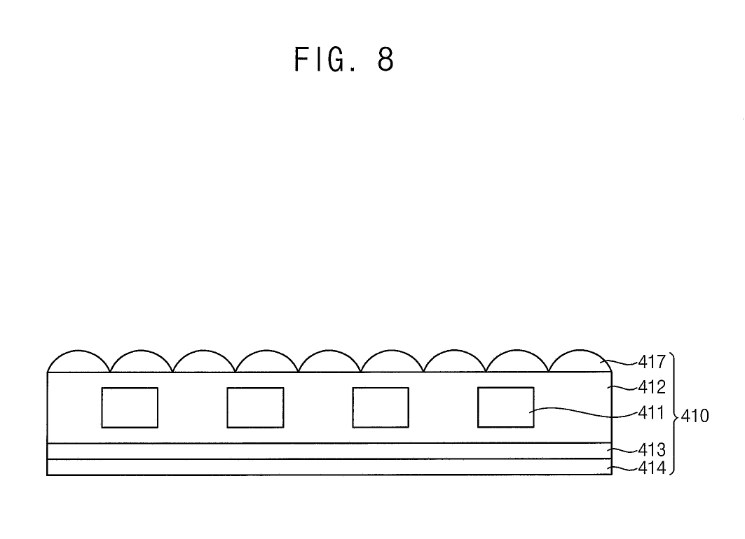

FIG. 8 is a front side view illustrating another exemplary embodiment of a backlight assembly of a display device according to the invention.

Referring to FIG. 8, a backlight assembly 410 includes a light source 411 and a light-guide plate which transfers a light from the light source 411 to a display panel such as a liquid crystal display panel disposed on the backlight assembly 410. The light-guide plate may include a light-guide member 412, a lenticular pattern 417 disposed on an upper surface of the light-guide member 412, a first high-refractive layer 413 covering a lower surface of the light-guide member 412, a quantum dot pattern disposed on a lower surface of the first high-refractive layer 413, and a second high-refractive layer 414 covering the quantum dot pattern and the lower surface of the first high-refractive layer 413. An upper surface of the lenticular pattern 417 may define the light exit surface of the backlight assembly 410.

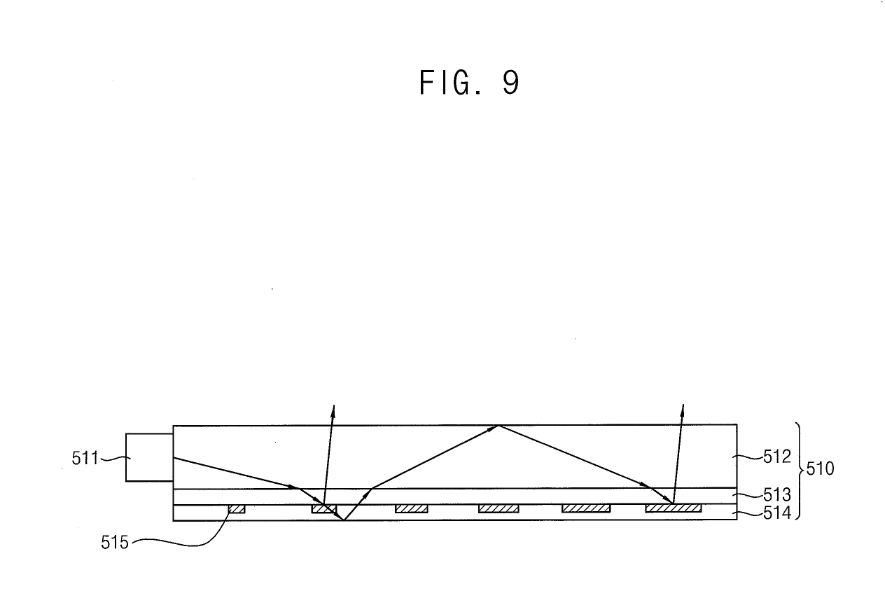

FIG. 9 is a cross-sectional view illustrating still another exemplary embodiment of a backlight assembly of a display device according to the invention.

Referring to FIG. 9, a backlight assembly 510 includes a light source 511 and a light-guide plate which transfers a light from the light source 511 to a display panel such as a liquid crystal display panel disposed on the backlight assembly 510. The light-guide plate may include a light-guide member 512, a first high-refractive layer 513 covering a lower surface of the light-guide member 512, a quantum dot pattern 515 disposed on a lower surface of the first high-refractive layer 513, and a second high-refractive layer 514 covering the quantum dot pattern 515 and the lower surface of the first high-refractive layer 513.

In an exemplary embodiment, an area density of the quantum dot pattern 515 may be smaller in a first area adjacent to (e.g., closer to) an incident surface than in a second area adjacent to (e.g., closer to) an opposing surface opposite to the incident surface.

In an exemplary embodiment, for example, an area density of the quantum dot pattern 515 may increase as a distance between the quantum dot pattern 515 and the incident surface increases. In an exemplary embodiment, for example, a size of the quantum dot pattern 515 may increase as a distance between the quantum dot pattern 515 and the incident surface increases.

An amount of a light passing through the area adjacent to the incident surface is more than an amount of a light passing through the area adjacent to the opposing surface. Thus, when an area density of the quantum dot pattern 515 is same in an entire area, an intensity of a light exiting from the light-guide plate may be not uniform. In an exemplary embodiment, since the planar area density or size of the quantum dot pattern 515 may be relatively smaller in a first area adjacent to the incident surface of the light-guide member 512 than in a second area adjacent to an opposing surface opposite to the incident surface, an intensity of a light exiting from the light-guide plate may be uniform in an entire area.

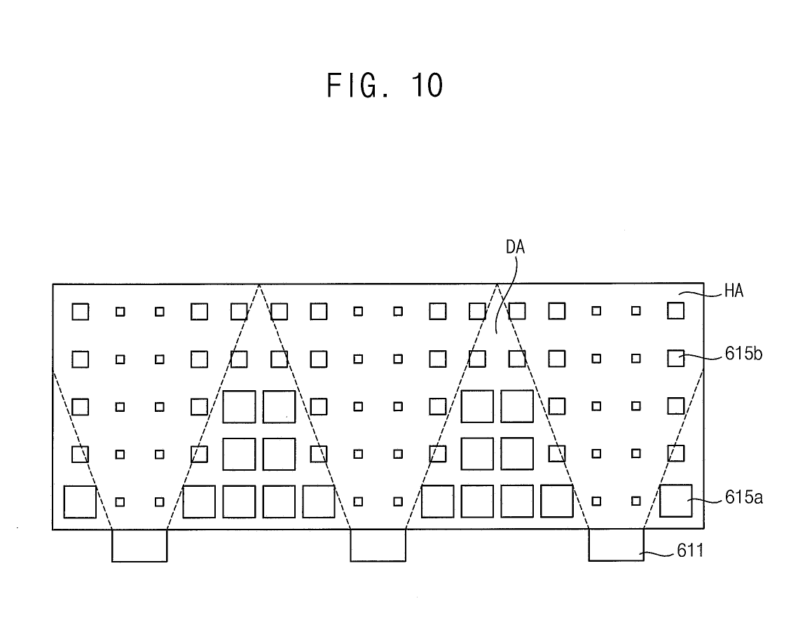

FIG. 10 is a top plan view illustrating an exemplary embodiment of a light source relative to a quantum dot pattern array of a backlight assembly of a display device according to the invention.

Even though a light source 611 is provided in plural arranged in a backlight assembly, brightness localization may appear. In an exemplary embodiment, for example, a brightness may be relatively reduced in an area adjacent to an incident surface which is between adjacent light sources 611 because of straightness of a light exiting directly from the light sources 611.

In an exemplary embodiment, an area density of a quantum dot pattern may be larger in a low brightness area DA than in a high brightness area HA. In an exemplary embodiment, for example, as illustrated in FIG. 10, a planar area of a quantum dot pattern 615a disposed in the low brightness area DA may be larger than a planar area of a quantum dot pattern 615b disposed in the high brightness area HA. However, exemplary embodiments are not limited thereto. That is, a planar area density of the quantum dot patterns may be relatively smaller in the high brightness area HA than in the low brightness area DA. Additionally, in a direction from the incident surface to the opposing surface, sizes of the quantum dot patterns may decrease.

In an exemplary embodiment, for example, for quantum dot patterns having a same size in both the low brightness area DA and high brightness area HA, the numbers of the quantum dot patterns may be different in the low brightness area DA relative to the high brightness area HA.

One or more of the above configurations may increase an intensity of a light exiting from the low brightness area DA thereby compensating for brightness localization generated in the light-guide plate.

One or more of a light-guide plate, a backlight assembly and a display device according to the invention described above may be applied to various electronic devices which have a display function such as a television, a monitor, a notebook computer, a tablet computer, a mobile phone, a home appliance or the like.

The foregoing is illustrative of exemplary embodiments and is not to be construed as limiting thereof. Although exemplary embodiments have been described, those skilled in the art will readily appreciate that many modifications are possible in the exemplary embodiments without materially departing from the novel teachings and features of the invention. Accordingly, all such modifications are intended to be included within the scope of the invention. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the invention, as set forth in the following claims and equivalents thereof.

What is claimed is:

1. A light-guide plate comprising:
a light-guide member through which light is guided to exit from an upper surface of the light-guide member; and
a high refractive index member covering a lower surface of the light-guide member which is opposite to the upper surface thereof, the high refractive index member comprising:
a first high-refractive layer and a second high-refractive layer having refractive indices equal to each other, each of the refractive indices being equal to or greater than a refractive index of the light-guide member; and
a quantum dot pattern which changes a wavelength of light incident thereto, disposed between the first high-refractive layer and the second high-refractive layer to dispose the first high-refractive layer between the light-guide member and the quantum dot pattern,
wherein an interface is formed between the second high-refractive layer, and each of the first high-refractive layer and the quantum dot pattern, respectively.

2. The light-guide plate of claim 1, wherein the light-guide member includes a material having a refractive index of about 1.4 to about 1.6.

3. The light-guide plate of claim 2, wherein the light-guide member includes glass.

4. The light-guide plate of claim 3, wherein the first high-refractive layer includes at least one selected from polymethylmethacrylate, polycarbonate and polycycloolefin.

5. The light-guide plate of claim 4, wherein the second high-refractive layer includes a same material as the first high-refractive layer.

6. The light-guide plate of claim 2, wherein the first high-refractive layer includes a metal oxide.

7. The light-guide plate of claim 1, wherein the quantum dot pattern includes a quantum dot and a scattering particle.

8. The light-guide plate of claim 1, further comprising a wire grid polarizer which selectively transmits or reflects light incident thereto, the wire grid polarizer disposing the light-guide member between the first high-refractive layer and the wire grid polarizer and defining a light exit surface of the light-guide plate.

9. The light-guide plate of claim 1, further comprising a wire grid polarizer which selectively transmits or reflects light incident thereto, the wire grid polarizer disposed between the light-guide member and the first high-refractive layer.

10. The light-guide plate of claim 1, further comprising a lenticular pattern layer covering the upper surface of the light-guide member, the lenticular pattern disposing the light-guide member between the first high-refractive layer and the lenticular pattern and defining a light exit surface of the light-guide plate.

11. A back-light assembly comprising:
a light source which generates and emits light; and
a light-guide plate which guides the light emitted from the light source to exit from the light-guide plate, the light-guide plate comprising:
a light-guide member through which the light emitted from the light source is guided to exit from an upper surface of the light-guide member, the light-guide member including an incident side surface through which the light emitted from the light source is incident into the light-guide member; and
a high refractive index member covering a lower surface of the light-guide member which is opposite to the upper surface thereof, the high refractive index member including:
a first high-refractive layer and a second high-refractive layer having refractive indices equal to each other, each of the refractive indices being equal to or greater than a refractive index of the light-guide member; and
a quantum dot pattern which changes a wavelength of light incident thereto, disposed between the first high-refractive layer and the second high-refractive layer to dispose the first high-refractive layer between the light-guide member and the quantum dot pattern,
wherein an interface is formed between the second high-refractive layer, and each of the first high-refractive layer and the quantum dot pattern, respectively.

12. The backlight assembly of claim 11, wherein
the light-guide member includes glass, and
the first high-refractive layer includes at least one selected from polymethylmethacrylate, polycarbonate and polycycloolefin.

13. The backlight assembly of claim 11, wherein
the light-guide member includes glass, and
the first high-refractive layer includes a metal oxide.

14. The backlight assembly of claim 11, wherein the second high-refractive layer includes a same material as the first high-refractive layer.

15. The backlight assembly of claim 11, wherein
the quantum dot pattern is provided in plurality between the first high-refractive layer and the second high-refractive layer, and
an area density of the quantum dot patterns is larger in a first area adjacent to the incident side surface than in a second area adjacent to an opposite side surface opposing the incident side surface.

16. The backlight assembly of claim 11, wherein
the light source is provided in plurality arranged along the incident side surface of the light-guide member, and
extending from the incident side surface in a direction away therefrom are:
a low brightness area between adjacent light sources, and
a high brightness area at the light sources,
wherein an area density of the quantum dot patterns is larger in the low brightness area than in the high brightness area.

17. A display device comprising:
a display panel which displays an image with light; and
a backlight assembly which provides the light to the display panel,
wherein the backlight assembly includes:
a light source which generates and emits the light; and
a light-guide plate which guides the light emitted from the light source to exit from the light-guide plate, the light-guide plate comprising:
a light-guide member through which the light emitted from the light source is guided to exit from an upper surface of the light-guide member, the light-guide member including an incident side surface through which the light emitted from the light source is incident into the light-guide member; and
a high refractive index member covering a lower surface of the light-guide member which is opposite to the upper surface thereof, the high refractive index member including:
a first high-refractive layer and a second high-refractive layer having refractive indices equal to each other, each of the refractive indices being equal to or greater than a refractive index of the light-guide member; and
a quantum dot pattern which changes a wavelength of light incident thereto, disposed between the first high-refractive layer and the second high-refractive layer to dispose the first high-refractive layer between the light-guide member and the quantum dot pattern,
wherein an interface is formed between the second high-refractive layer, and each of the first high-refractive layer and the quantum dot pattern, respectively.

18. The display device of claim 17, wherein
the light-guide member includes glass, and
the first high-refractive layer includes at least one selected from polymethylmethacrylate, polycarbonate and polycycloolefin.

19. The display device of claim 17, wherein
the light-guide member includes glass, and
the first high-refractive layer includes a metal oxide.

20. The display device of claim 17, wherein
the light source is provided in plurality arranged along the incident side surface of the light-guide member, and
extending from the incident side surface in a direction away therefrom are:
a low brightness area between adjacent light sources, and
a high brightness area at the light sources,
wherein an area density of the quantum dot patterns is larger in the low brightness area than in the high brightness area.
